(19) United States
(12) Patent Application Publication
(10) Pub. No.: US 2006/0060686 A1
(43) Pub. Date: Mar. 23, 2006

(54) Spice grinder in combination with a shaker

(76) Inventor: Shung-I Cheng, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/945,979

(22) Filed: Sep. 22, 2004

(51) Int. Cl. A47J 42/00

(52) U.S. Cl. 241/169.1

(57) ABSTRACT

A spice grinder includes a hollow container having a first opening and a second opening respectively communicating with exterior of the container, a skirt rotatably mounted around the hollow container, a hollow cap detachably supported by the skirt so as to alternately close the communication between an interior and the exterior of the hollow container, the hollow cap having multiple slits defined in a top face thereof and being provided for receiving therein condiment and a grinding device for grinding spice received in the hollow container.

### BACKGROUND OF THE INVENTION

1. Field of the Invention

The present invention relates to a spice grinder and a shaker, and more particularly to the combination of the spice grinder and the shaker.

2. Description of Related Art

In a restaurant, waiters will come to the tables to serve the customers freshly-ground pepper with a grinder in which pepper corn is ground into powder-like particles so that only pepper particles below a certain size are able to pass through the mesh on the grinder. After the addition of pepper to the food, the customers sometimes may request the addition of some other condiment e.g. rock salt, clove or the like. Then the waiter will have to fetch the condiment shaker and add in whatever the customer requires. As we all have experienced holding a bulky pepper grinder in one hand and a shaker in the other, we know it is quite inconvenient and awkward.

To overcome the shortcomings, the present invention tends to provide an improved spice grinder to mitigate the aforementioned problems.

### SUMMARY OF THE INVENTION

The primary objective of the present invention is to provide an improved spice grinder having a hollow cap detachably mounted on one of two openings in a container to receive therein condiment such that the grinder not only has a function of grinding spice, but also has a function of supplying alternative condiment.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the combination of the present invention;

FIG. 2 is a cross sectional view of the combination in FIG. 1 along line 2-2;

FIG. 3 is a schematic cross sectional view showing how the spice in the grinder is ground; and

FIG. 4 is a schematic exploded perspective view showing that the cap of the spice grinder is removed and the condiment inside the cap is shaken out of the cap.

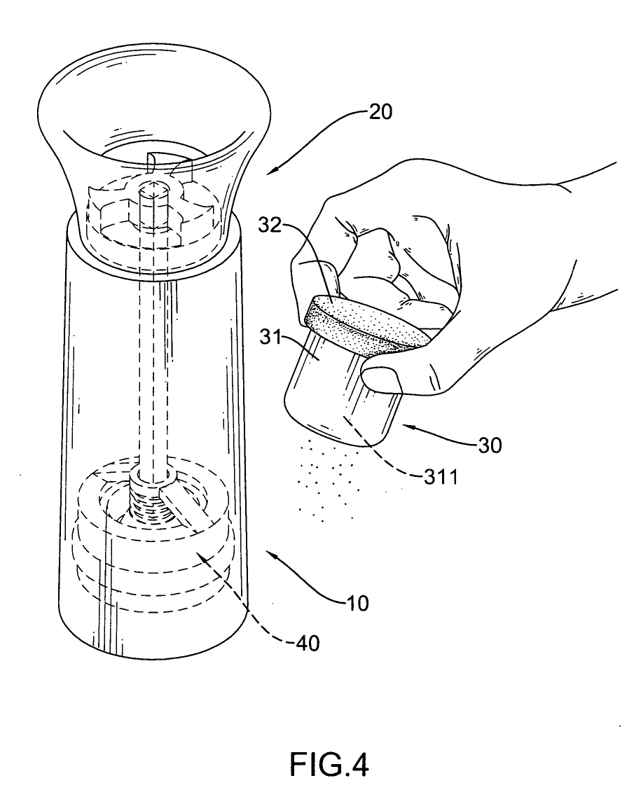

### DETAILED DESCRIPTION OF THE PREFERRED EMBODIMENT

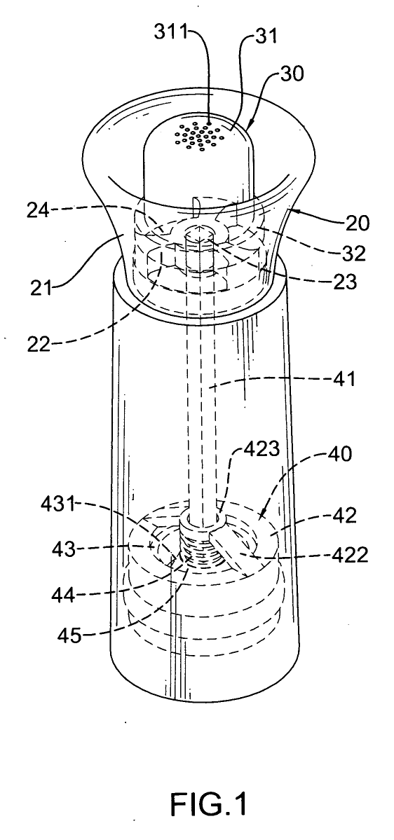

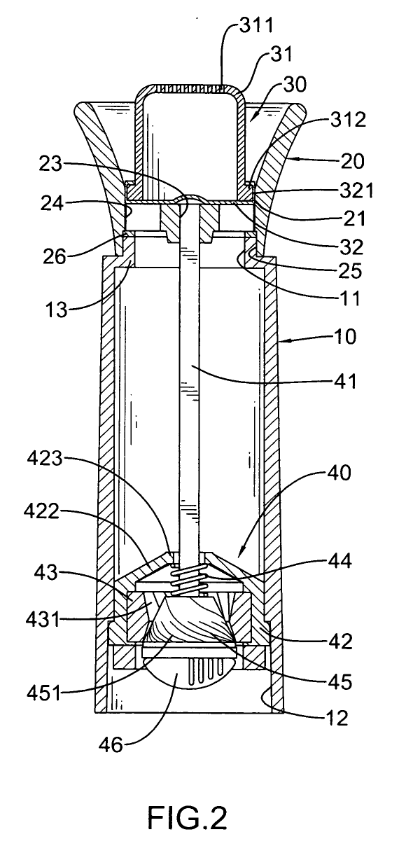

With reference to FIGS. 1 and 2, the spice grinder in accordance with the present invention includes a hollow container (10) having a first opening (11) and a second opening (12), a cap (30) detachably mounted on one of the first opening (11) and the second opening (12) of the container (10) (the cap (30) is detachably mounted on the first opening (11) of the container (10) in this embodiment) and a grinding mechanism (40) inside the container (10).

The container (10) has a neck (13) formed on a top portion of the container (10) and a skirt (20) securely connected to the neck (13). The skirt (20) has a tapered inner side wall (21), ribs (22) extending from the tapered inner side wall (21) toward a center of the skirt (20), an assembly hole (23) defined in the joint of the ribs (22) and gaps (24) defined between two adjacent ribs (22). Furthermore, a cutout (25) is defined in a lower portion of the tapered inner side wall (21) to correspond to and receive therein the neck (13) of the container (10). A pad (26) is sandwiched between a top face of the neck (13) and a side face defining the cutout (25) to reduce friction between the container (10) and the skirt (20) after the neck (13) is received in the cutout (25).

The cap (30) is hollow and supported by the skirt (20). That is, the cap (30) stops communication between an interior of the container (10) and an exterior of the container (10) when the cap (30) is situated in and supported by the skirt (20). The cap (30) has a top face (31) provided with multiple slits (311) to allow a communication between an interior of the cap (30) and an exterior of the cap (30), and a bottom face formed by a resilient plate (32). The cap (30) has a flange (312) extending outward from a bottom edge of the cap (30) and the bottom face (32) of the cap (30) has a bend (321) integrally formed with the bottom face (32) to enclose the flange (312) so that when the cap (30) is situated in and supported by the skirt (20), engagement between the bend (321) and the tapered inner side wall (21) seals the communication of the gaps (24) with exterior of the container (10).

The grinding mechanism (40) includes a driving shaft (41) having a first end securely extending into the assembly hole (23) of the skirt (20) and a second end, a positioning seat (42) fixedly mounted inside the container (10) and having arms (422) inclinedly and convergently extending upward to form a supporting ring (423) by free ends of the arms (422), a first tapered block (43) securely received inside the positioning seat (42) and provided with multiple first grooves (431) defined in an inner face of the first tapered block (43) and a second tapered block (45) securely connected to the second end of the driving shaft (42) and received in the first tapered block (43). The second tapered block (45) has multiple second grooves (451) defined in an outer face of the second tapered block (45) to correspond to the first grooves (431). A spring (44) is sandwiched between the supporting ring (423) and a top face of the second tapered block (45) to constantly apply a force to the second tapered block (45) to maintain the second tapered block (45) apart from the first tapered block (43) for a distance. A cover (46) is also threadingly connected to the second end of the driving shaft (41) to sandwich the second tapered block (45) with the spring (44). Because the cover (46) is threadingly connected to the second end of the driving shaft (41), rotation of the cover (46) relative to the driving shaft (41) is able to adjust the distance between the first tapered block (43) and the second tapered block (45). Furthermore, the first grooves (431) have a direction opposite to that of the second grooves (451).

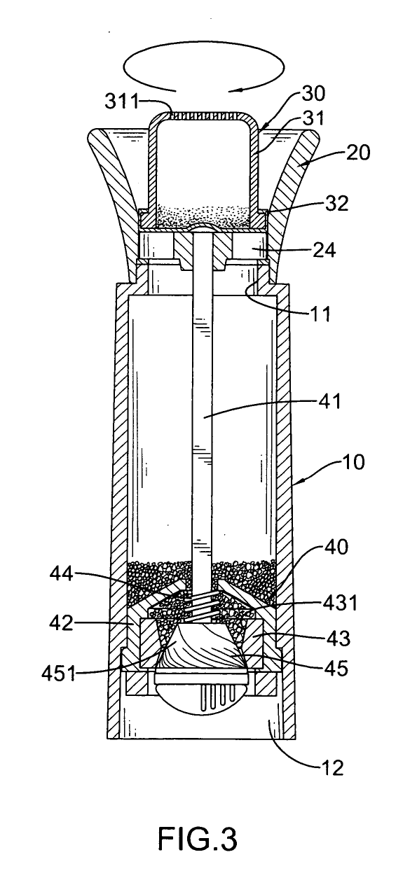

With reference to FIG. 3, when the spice grinder is in use, the cap (30) is removed to allow the interior of the container (10) to communicate with the exterior of the container (10) via the gaps (24) such that condiment particles are able to be fed into the container (10) via the gaps (24) and the first opening (11) of the container (10). After the condiment particles are fed into the container (10), rotation of the skirt (20) will facilitate the rotation of the driving shaft (41) as well as the second tapered block (45) and thus the condiment particles between the first tapered block (43) and the second tapered block (45) will be ground. The ground condiment powder will then be dispersed out of the container (10).

When another condiment is required, the user is able to remove and then reverse the cap (30) to allow the condiment received inside the hollow cap (30) to escape from the cap (30) via the slits (311).

While the cap (30) is removed for dispersing condiment, the spice grinder is still kept standing upright. That is, inside the spice grinder, the ground spice powder is kept at the bottom of the container (10) and the unground spice is kept away from direct engagement with air so that the unground spice is able to keep its freshness.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A spice grinder comprising:
a hollow container having a first opening and a second opening respectively communicating with an exterior of the container;
a skirt rotatably mounted around the hollow container;
a hollow cap detachably supported by the skirt so as to alternately close the communication between an interior and the exterior of the hollow container, the hollow cap having multiple slits defined in a top face thereof and being provided for receiving therein condiment; and
means for grinding spice received in the hollow container.

2. The spice grinder as claimed in claim 1, wherein the hollow container has a neck, and the skirt has a cutout defined in a bottom edge of the skirt to securely engage with a top face of the neck.

3. The spice grinder as claimed in claim 2, wherein a pad is sandwiched between the top face of the neck and a side face defining the cutout so as to reduce friction therebetween.

4. The spice grinder as claimed in claim 3, wherein the hollow cap has a flange extending outward from a bottom edge of the hollow cap and a resilient bottom face having a bend to enclose the flange and to engage with a tapered inner side wall of the skirt.

5. The spice grinder as claimed in claim 4, wherein the skirt has ribs extending toward a center of the skirt to form an assembly hole at a joint of the ribs and gaps each defined between two adjacent ribs to communicate with the first opening of the hollow container.

6. The spice grinder as claimed in claim 5, wherein the grinding means comprises:
a driving shaft having a first end extending into and securely received in the assembly hole and a second end;
a positioning seat securely mounted inside the hollow container and having arms inclinedly extending upward to form a supporting ring;
a first tapered block securely received in the positioning seat and having multiple first grooves defined in an inner face of the first tapered block;
a second tapered block threadingly connected to the second end of the driving shaft and received in the first tapered block, the second tapered block having multiple second grooves corresponding to the first grooves; and
a spring sandwiched between the supporting ring and the second tapered block to constantly apply a force to the second tapered block to maintain the first tapered block apart from the second tapered block.

7. The spice grinder as claimed in claim 6, wherein the first grooves have a direction opposite to that of the second grooves.

8. The spice grinder as claimed in claim 6 further comprising a cover threadingly connected to the second end of the driving shaft to adjust a distance between the first tapered block and the second tapered block.

9. The spice grinder as claimed in claim 7 further comprising a cover threadingly connected to the second end of the driving shaft to adjust a distance between the first tapered block and the second tapered block.
